(19) United States
(12) Patent Application Publication
(10) Pub. No.: US 2026/0214093 A1
(43) Pub. Date: Jul. 23, 2026

(54) METHOD AND SYSTEMS FOR IMPROVING COMPUTER NETWORK SECURITY

(71) Applicant: Visa International Service Association, San Francisco, CA (US)

(72) Inventor: Simon HOPLEY, Wiltshire (GB)

(73) Assignee: Visa International Service Association, San Francisco, CA (US)

(21) Appl. No.: 19/135,112

(22) PCT Filed: Dec. 19, 2022
(86) PCT No.: PCT/US2022/081950

§ 371 Date: Jun. 3, 2025

(51) Int. Cl. H04L 9/40

(52) U.S. Cl. CPC H04L 63/0884; H04L 63/1416; H04L 63/1425

(57) ABSTRACT

Automated systems and methods for monitoring computer networks via an intelligent widget, the system comprising an enterprise network comprising connected devices; the system configured to undertake a set of security monitoring activities for each of the connected devices, comprising instructions to detect a device of the connected devices logging into the enterprise network; detect a web call by the device to a web address via a proxy; generate a login log; generate a proxy log; combine data from the login log and the proxy log into concatenated data; aggregate the concatenated data from the device with concatenated data from the connected devices into aggregate data. The system comprising an admin device configured to receive the aggregate data to allow processing and display of selected content from the aggregate data; and display dynamically on a graphical user interface of the intelligent widget the selected content to monitor the enterprise network.

### TECHNICAL FIELD

The present disclosure concerns automated enterprise network security systems and methods, designed to detect, identify and manage cyber security threats automatically based on generated data associated with security threats from patterns and data generated from the network. In some aspects, the technologies herein disclose an autonomous command and control AI widget.

### SUMMARY

In various aspects, the present disclosure presents a computer-implemented method for improving security of a computer network, the computer-implemented method comprising extracting login telemetry, wherein the login telemetry comprises login records of successful logins to computers in the computer network, and wherein the login telemetry comprises login time stamps associated with the successful logins; extracting proxy logs, wherein the proxy logs comprise records of web calls made from the computers of the computer network to destination websites after the successful logins, and wherein the proxy logs comprise web-call time stamps associated the web calls; generating concatenated contents from the login telemetry and the proxy logs; deleting a first subset of concatenated contents from the concatenated contents for failure to satisfy a time-based selection criterion; deleting a second subset of concatenated contents from the concatenated contents for validating with an allowed list; deleting a third subset of concatenated contents from the concatenated contents for failure to satisfy a time-based login threshold; determining a data upload parameter associated with an undeleted subset of the concatenated contents; and identifying anomalous behavior associated with the undeleted subset of the concatenated contents based on determined values of the data upload parameter.

In numerous aspects, the allowed list comprises allowed source hosts.

In numerous aspects, the allowed list comprises allowed destination websites.

In numerous aspects, the data upload parameter comprises a data upload rate.

In numerous aspects, the data upload parameter comprises a data upload period.

In numerous aspects, the computer-implemented method further comprises triggering an alert based on an identification anomalous behavior.

In numerous aspects, the computer-implemented method further comprises deleting a malicious code.

In numerous aspects, the computer-implemented method further comprises updating a watch list based on the undeleted subset of the concatenated contents that associate with a malicious code.

In various aspects, the present disclosure provides a computer-implemented method for improving security of a computer network, the computer-implemented method comprising retrieving login telemetry, wherein the login telemetry comprises login records of successful logins to computers in the computer network, and wherein the login telemetry comprises login time stamps associated with the successful logins; retrieving proxy logs, wherein the proxy logs comprise records of web calls made from the computers of the computer network to destination websites after the successful logins, and wherein the proxy logs comprise web-call time stamps associated the web calls; generating concatenated contents from the login telemetry and the proxy logs; deleting a subset of concatenated contents from the concatenated contents for failure to satisfy a time-based selection criterion; deleting a second subset of concatenated contents from the concatenated contents for validating with an allowed list; deleting a third subset of concatenated contents from the concatenated contents for failure to satisfy a time-based login threshold; determining a data upload parameter associated with a remaining subset of the concatenated contents; and identifying malicious code associated with the remaining subset of the concatenated contents based on determined values of the data upload parameter.

In numerous aspects, the allowed list comprises allowed source hosts.

In numerous aspects, the allowed list comprises allowed destination websites.

In numerous aspects, the data upload parameter comprises a data upload rate.

In numerous aspects, the data upload parameter comprises a data upload period.

In numerous aspects, the computer implemented method further comprises triggering an alert based on identifying the malicious code.

In numerous aspects, the computer implemented method further comprises deleting the malicious code.

In numerous aspects, the computer implemented method further comprises updating a watch list based on an undeleted subset of the concatenated contents that associate with the malicious code.

In various aspects, the present disclosure provides an automated system for monitoring computer networks via an intelligent widget, the system comprising an enterprise network comprising connected devices; and a memory storing instructions executable by a processor configured to undertake a set of security monitoring activities for each of the connected devices, wherein the instructions cause the processor to detect a device of the connected devices logging into the enterprise network, the device associated with a user known to the enterprise network; detect a web call by the device to a web address via a proxy; generate a login log comprising a login record and an associated login timestamp of the device; generate a proxy log comprising a web call record of the device and an associated web call timestamp of the device; combine data from the login log and the proxy log into concatenated data; aggregate the concatenated data from the device with concatenated data from the connected devices into aggregate data; and an admin device of the connected devices associated with an administrator known to the enterprise network, wherein the admin device is configured to receive the aggregate data to allow processing and display of selected content from the aggregate data; exclude a subset of the aggregate data based on predetermined criteria; and display dynamically on a graphical user interface of the intelligent widget the selected content to allow monitoring of activity occurring on the enterprise network.

In numerous aspects, the selected content dynamically displayed comprises at least one of a live login status of the connected devices, a live web call status of the connected devices, communications between the connected devices, communications between the connected devices and external servers or destinations, a triggered event or alert, a status of a triggered event or alert, an allow list, and a command and control watch list.

In numerous aspects, the instructions executable by the processor further comprise identify in the aggregate data a first group of entries that fall outside a predetermined time-criteria; identify in the aggregate data a second group of entries associated to web addresses in an allow list; identify in the aggregate data a third group of entries that fall outside a predetermined date range; delete the first group, the second group, and the third group of entries from the aggregate data; and for each remaining data entry in the aggregate data, trigger a security information and event management event based on a match between the data entry and a command and control watch list, or add the data entry to the command and control watch list based on an absence of matches with the command and control list.

In numerous aspects, the security information and event management event comprises instructions executable to automatically display on the intelligent widget an option selectable to undertake at least one of sequester the device from the network; delete malicious code or script from the device; issue an alert to the device; disable the device; shut down the enterprise network; or display event or alert options on the widget, the event or alert options selectable by the administrator, or a combination thereof.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates one aspect of a system comprised of various enterprise network components and implementable methods to identify and manage command and control threats according to at least one aspect of the present disclosure.

FIG. 2 illustrates a flow diagram for one aspect of a method to improve security of a computer network, according to at least one aspect of the present disclosure.

FIG. 3 illustrates a flow diagram for an aspect of a method to monitor computer networks via an intelligent widget, according to at least one aspect of the present disclosure.

FIG. 4A-4C illustrate comprehensive systems and methods to manage command and control threats, according to at least one aspect of the present disclosure.

FIG. 5 presents a block diagram of a computer apparatus, according to at least aspect of the present disclosure.

FIG. 6 is a diagrammatic representation of an example system that includes a host machine within which a set of instructions to perform any one or more of the methodologies discussed herein may be executed.

### DESCRIPTION

The following disclosure may provide exemplary systems, devices, and methods for the monitoring and management of security threats and related activities. Although reference may be made to such security threats in the examples provided below, aspects are not so limited. That is, the systems, methods, and apparatuses may be utilized for any suitable purpose.

Before discussing specific embodiments, aspects, or examples, some descriptions of terms used herein are provided below.

An “application” may include any software module configured to perform a specific function or functions when executed by a processor of a computer. For example, a “mobile application” may include a software module that is configured to be operated by a mobile device. Applications may be configured to perform many different functions. Further, an “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

The terms “client device” and “user device” refer to any an electronic device that may be transported and/or operated by a user, and/or that is configured to communicate with one or more servers or remote devices and/or systems. The user or client device may be configured to transmit and receive data or communications to and from other devices. In some embodiments or aspects, the client device or user device may be portable. A client device or a user device may include a mobile device, a network-enabled appliance (e.g., a network-enabled television, refrigerator, thermostat, and/or the like), a computer, a POS system, and/or any other device or system capable of communicating with a network. A client device may further include a desktop computer, laptop computer, mobile computer (e.g., smartphone), a wearable computer (e.g., a watch, pair of glasses, lens, clothing, smart watches, fitness bands, ankle bracelets, rings, earrings, and/or the like), a cellular phone, a network-enabled appliance (e.g., a network-enabled television, refrigerator, thermostat, and/or the like), a point of sale (POS) system, and/or any other device, system, and/or software application configured to communicate with a remote device or system. Examples of user devices may also include vehicles with computing abilities, such as automobiles with remote communication capabilities.

As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments or aspects, a message may refer to a packet (e.g., a data packet, a network packet, and/or the like) that includes data. It will be appreciated that numerous other arrangements are possible.

A “communication channel” may refer to any suitable path for communication between two or more entities. Suitable communications channels may be present directly between two entities such as a payment processing network and a merchant or issuer computer, or may include a number of different entities. Any suitable communications protocols may be used for generating a communications channel. A communication channel may in some instances comprise a “secure communication channel” or a “tunnel,” either of which may be established in any known manner, including the use of mutual authentication and a session key and establishment of a secure communications session. However, any method of creating a secure communication channel may be used, and communication channels may be wired or wireless, as well as long-range, short-range, or medium-range.

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like. A computer or computing device may be a user device or client device.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously recited server and/or processor that is recited as performing a function, a different server and/or processor, and/or a combination of servers and/or processors. For example, as used in the specification and the claims, a first server and/or a first processor that is recited as performing a function may refer to the same or different server and/or a processor recited as performing a function.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

As used herein, the term “system” may refer to one or more computing devices or combinations of computing devices (e.g., processors, servers, client devices, software applications, components of such, and/or the like).

A “user” may include an individual. In some embodiments or aspects, a user may be associated with one or more personal accounts and/or mobile devices. The user may also be referred to as a cardholder, account holder, or consumer.

“User information” may include any information that is associated with a user. For example, the user information may include a device identifier of a device that the user owns or operates and/or account credentials of an account that the user holds. A device identifier may include a unique identifier assigned to a user device that can later be used to verify the user device. In some embodiments or aspects, the device identifier may include a device fingerprint. The device fingerprint may an aggregation of device attributes. The device fingerprint may be generated by a software development kit (SDK) provided on the user device using, for example, a unique identifier assigned by the operating system, an International Mobile Station Equipment Identity (IMEI) number, operating system (OS) version, plug-in version, and the like.

Reference to “a device,” “a server,” “a processor,” and/or the like, as used herein, may refer to a previously recited device, server, or processor that is recited as performing a function, a different server or processor, and/or a combination of servers and/or processors. For example, as used in the specification and the claims, a first server or a first processor that is recited as performing a first function may refer to the same or different server or the same or different processor recited as performing a second function.

A common challenge in enterprise networking security, is the issue of cyber security threats that arise from a malicious actor (also referred to herein as “adversary”) being able to gain a foothold within the enterprise. A malicious actor may be able to gain a foothold by accessing a computing device or machine within the enterprise. This may be done by injecting malware or other malicious scripts into the computing device, which may be a user device or machine of an employee or executive for example. The malicious scripts execute calls to external servers to establish a connection or a communication channel with these external, adversary controlled or coopted servers or hosts. This allows the malicious actor to utilize command and control (also referred to as “C2”) tools and methods to maintain or expand communication between the malicious actor and the compromised user device or network. C2 is used by malicious actors to steal information by piping back to the malicious actor or downloading additional malicious programs onto the compromised device or network. The malicious actor may also use the C2 to gain access to other devices within the enterprise, until reaching a valuable device such as a database containing valuable information.

C2 methods and tools are difficult to detect once communication is initiated since communications may take the form of outbound connections to servers and websites that may not be suspicious, which may be inadvertently serving as nodes in the adversary's C2 infrastructure, i.e., servers, hosts, and websites that themselves have been infiltrated to serve as a communication node for the malicious actor C2 infrastructure. Furthermore, many security systems focus their monitoring on inbound traffic and files instead of outbound traffic missing various communications to malicious servers of an adversary. The amount of both inbound, and outbound activity, calls, and traffic, as well as internal processes and tasks creates a large amount of noise that makes it difficult to distinguish malicious activity from regular activity in the enterprise network. Traditionally, to combat these threats, enterprise networks rely on created lists of bad or malicious actors or websites, which deny access to services or servers. The IP addresses or the servers themselves may be easily modified by the adversary making it easy to detect evasion, and making the created lists of previously encountered threats redundant or dated.

The technologies disclosed present a variety of systems and methods that automatically and autonomously detect, identify, and manage a variety of threats, and malicious activities on an enterprise network related to command and control infrastructure of an adversary who has obtained a foothold in the enterprise network. This is achieved by scalable systems and methods that are structured to autonomously collect network data, detect patterns associated with malicious activity on a network, and implement responses to detected or identified threats.

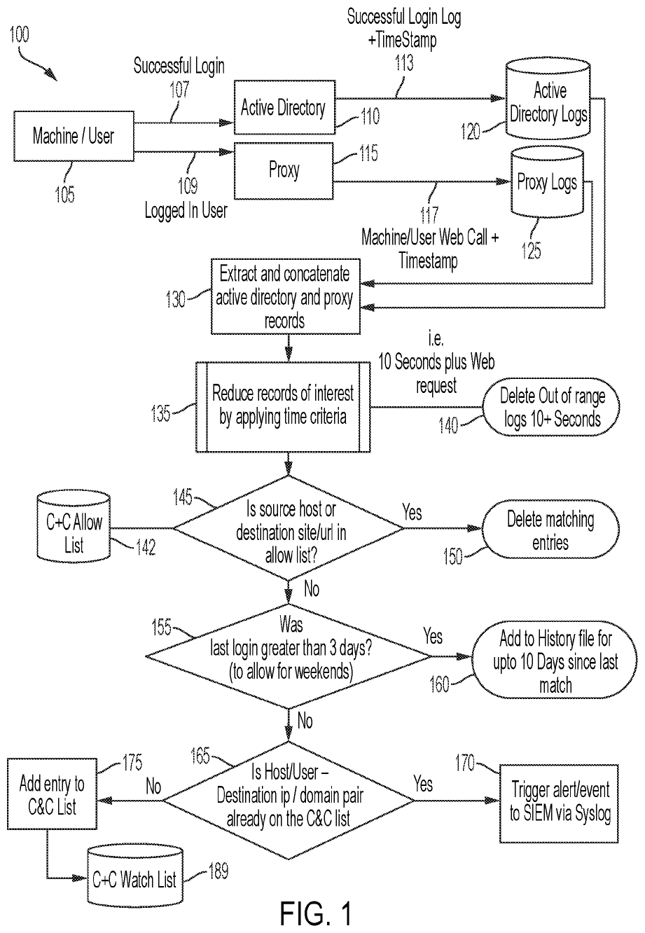

FIG. 1 illustrates a system 100 comprised of various enterprise network components and methods to identify and manage command and control threats according to at least one aspect of the present disclosure. System 100 (also referred to herein as “enterprise 100”, “network 100”, and “enterprise network 100”), which may comprise an enterprise network, and may include one or more computing or networking devices, client devices, machines, or user devices 105 (collectively referred to herein as “user device(s)”). A user device 105, may include devices for any individual connected to the enterprise network, including employees, contractors, including security and network administrators. Enterprise 100 may be a local or a distributed system or a combination of both. Multiple user devices may be connected via and/or to system 100. A user, for example, may be an employee or a contractor of an organization that owns enterprise 100. The user may login 107 into user device 105, for example a work laptop or computer. A user may also be, for example, a guest user that is issued a temporary user name and password, or guest account credentials. Once a user logs in 107 successfully, they are able to access active directory 110 which may include one or more directories, files, folders, programs, virtual machines, or applications that are part of, or connected to, enterprise 100. User device 105, or enterprise 100, may generate login information 113 that may include a time stamp of successful login 107, and/or a successful login log of user device 105. Login information 113 may then in various aspects be automatically copied to, or stored in, active directory logs 120.

An already logged in 109 user or user device 105 may also access a perimeter internet filtering telemetry or perimeter technology 115 (which may be a proxy server 115 and be referred to as such), to connect to the web, the perimeter internet filtering telemetry or perimeter technology 115 may be a service or a technology such as a proxy server 115, which allows communication or forms a communication channel to an external website, URL or web addresses, IP address, server, external hosts (collectively referred to herein as “destination”), and acts as an intermediary between a client requesting a resource and the server providing that resource. This perimeter internet filtering telemetry 115 may be also be architected in non-proxy environments where firewall URL filtering is in use or Secure Access Services Edge (SASE) logs and this will differ from enterprise to enterprise. All these forms of perimeter internet filtering telemetry or perimeter technology 115 may be referred to collectively herein as “proxy server”, “proxy”, “internet filtering telemetry”, or “perimeter technology” relating to this as well as any other Figures in this disclosure.

Logged in user 109, with access to enterprise 100, may connect to destinations such as external websites or servers through proxy 115 via web calls made by user device 105. User device 105, proxy 115, or enterprise 100 may generate web access information 117 that may include information about specific web calls made by user device 105 such as an IP address, as well as timestamps associated with the web calls made. Web access information 117 may include any type of information, data, or files exchanged as a result of the web call. Web access information 117 may be copied to, or stored in, proxy logs 125.

Active directory logs 120 and proxy logs 125 may each be comprised of various logs, files, folders and databases. Login information 113 and web access information 117 stored in active directory logs 120 and proxy logs 125, respectively, may be identified, searched, extracted, copied, edited, retrieved, or pulled to be concatenated 130 together into concatenated records. Based on the timestamps generated in login information 113 and web access information 117, time criteria could be applied 135 to the concatenated records so that they may be reduced by deleting 140 any record that falls outside of a specific date, time, or time range/difference, for example logs generated within a specific time range, such as 10 seconds, from a login or web access request. Once records are reduced by applying 135 time criteria to them and undertaking a delete 140, enterprise 100 determines 145 whether the destination such as the website, URL, IP address, or the server accessed, via a web call for example, is in one or more allow lists 142 (also referred to herein as “whitelist” or “C&C allow list”) maintained by enterprise 100. If the destination is in an allow list 142 then the entries from the combined records at concatenation 130 may be further reduced by deleting 150 entries from active directory logs 120 and proxy logs 125 that are in, or match entries in the allowed list.

The concatenated records may be further reduced by identifying 155 the date of the last login, and if the last login is outside of a predefined time-range, for example 3 days, the entries associated with login records outside of the predefined time-range may either be deleted or archived, for example by transferring or copying 160 into a history directory, file, folder or database in system 100. Whereupon the relevant entries may be kept for a certain period, such as a predefined number of days, weeks, or the like. If it is determined 165 that the destination, user device 105 login information 113 or a combination are on a command and control list or command and control watch list 189 (these referred to herein as “C&C watch list”), or blacklist, then an alert or event may be triggered 170, for example in a security information and event management system (“SIEM”). Alerts, notifications, may be issued to one or more devices in enterprise 100. Alternatively events to respond to security threats may be initiated by SIEM or system 100. If the destination, user device login information 113, or combinations of these, are not already on the command and control list 189 then the entry related to them is added 175 to the command and control list 189. In various aspects, data regarding events or processes 130-175 may be labeled and utilized and fed into a machine learning network to train it to be automatically able to determine what decisions to make at each event in system 100, or as input to train a reinforcement machine learning model (the machine learning models are collectively referred to herein as “ML model”).

Patterns are identified in the data generated by the system, in various aspects by reinforcement machine learning or other machine learning algorithms and processes. Once patterns are identified then, new rules, or recognized situations or specific combinations of data points may be automatically created, that may trigger specific actions in enterprise 100. For example, enterprise 100 may recognize various iterations of the methods described, in which specific combinations, or factors in login information 113 and/or web access information 117 may be related to specific actions, such as specific events or processes 130-175 leading to adding an entry to C&C watch list 189 or triggering alerts or events in the SIEM. In various example aspects, user devices 105 that initiate a web call within a specific time range from a successful login 107, or a web call within a certain range from a specific time or date, may be flagged by enterprise 100 to be an event that is of concern, and necessitates triggering of an action, such as an alert to or by the SIEM.

In various aspects, for enterprise 100 to flag an event or entry, such as those in the concatenated records, as a security concern, which triggers an alert or other security response, enterprise 100 may require the satisfaction of security threat thresholds, which may be derived from one or more conditions, or a combination of conditions. In some aspects, the timing of conditions or combination of conditions also effects the security threat thresholds. In various aspects in order to meet or reach a security threat threshold and trigger a security response, some or all of these conditions may have to occur simultaneously. For example, enterprise 100 may determine or identify that a web call is made within a certain time or time frame, and this may on its own trigger an alert, however in other configurations or aspects, a web call has to be made during a certain time or time frame in combination with other factors, such as the destination of the call itself having a high risk value. In various aspects a high-risk destination may on its own meet the security threshold to trigger a security response. In some aspects, the number or rapidity of web calls may also trigger a security response. Several combinations, conditions, or factors may be used by the enterprise 100 depending on the security conditions in the network. A destination as discussed herein may include non-limiting examples such as a host server, website, service, or IP address.

Various security actions or responses may be autonomously undertaken by system 100, including, adding or removing not just the concatenated entries, but fields and specific data points such as events, timestamps, destinations, and the like from remaining records or the concatenated records, in the C&C watch list 189, or in the C&C allow list 142, and/or archive, copy, or transfer any of these data between these various records, databases, and lists.

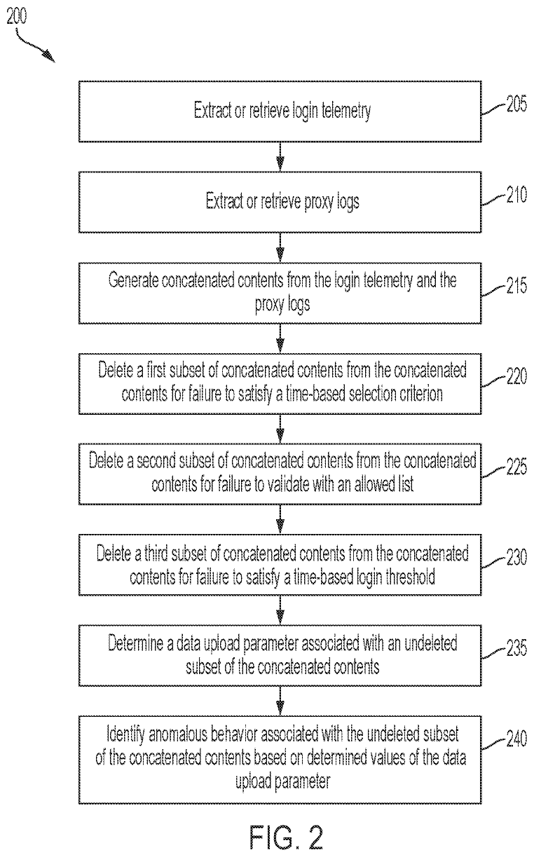

FIG. 2 illustrates a flow diagram for one aspect of a method 200 to improve security of a computer network, according to at least one aspect of the present disclosure. With reference now primarily to FIG. 2 together with FIG. 1, in various aspects, the method 200 to improve security of a network may include extracting or retrieving 205 login telemetry. Login telemetry may include data associated with a machine logging into a network such as enterprise 100, FIG. 1. Data may include timestamps and login logs contained in login information 113. A machine such as user device 105, FIG. 1 may generate or have various types of data associated with it. This machine related or user device data may be included in any of the logs 120, 125 or other records available to a network, such as enterprise 100. Non-limiting examples of such data may include information related to the hardware of the machine or user device, the software it operates, user data, historical login information, and historical activity information of user device 105 and the like.

Method 200 may also extract or retrieve 210 proxy logs. Proxy logs may include web call information 117 such as destinations, IP addresses, communications made to external servers, and timestamps and responses associated with call information 117. Extraction or retrieval 205, 210 of login telemetry or login information 113, or that of proxy logs or web call information 117 may be conducted by enterprise 100 or a container, application, or dedicated enclave of enterprise 100.

With continued reference primarily to FIG. 2 together with FIG. 1, method 200 may also generate data or information that is concatenated 215 from the contents of login telemetry and proxy logs that are extracted or retrieved. In various aspects, the information may be parsed, and selectively extracted 205, 210 based on either rules or configurations provided to enterprise 100 or based on learned behaviors from historical events of enterprise 100. For example, a reinforcement machine learning model, may over time be trained on data in enterprise 100, and the actions and events selected by the system is used as the target, or target output, in the training of the model. For example, the model may learn which content to extract 205, 210, and which portion of the extracted or retrieved information should be concatenated. System 100 may be provided time selection criteria. These criteria may be configured or set manually, or they may be set automatically, based on a threshold that is learned based on reinforced learning that may use as inputs previous data sets and data points, and actions taken by enterprise 100 or manually by a user in response to specific events or data points. Method 200 may for example, delete 220 a first subset of concatenated contents from the concatenated contents for failure to satisfy a time-based selection criterion. The first subset may not meet a time window or a time range. The time window may comprise certain time or date ranges. The time-based selection criterion may use an event or a timestamp in the concatenated contents as a reference point from which a time range may be calculated, where records are deleted if they fall outside that time range. An entry in the concatenated content may be of a login timestamp, if the login timestamp is outside a time window, for example 3 days. It may then be deleted 220 as part of the first subset of data similar to event or process 140 in FIG. 1.

With continued reference primarily to FIG. 2 together with FIG. 1, method 200 may delete 225 a second subset of concatenated contents from the concatenated contents for validating with an allowed list, for example by matching entries in an allowed list. The concatenated contents may be contents concatenated at event or process 130, FIG. 1 for example, and may include contents of login telemetry, proxy logs as well as other data from the user devices and the enterprise network. For example, a website or URL may be placed on the allowed list, and any web calls to that specific website or URL is deleted and is considered to be not of concern for further monitoring, and is, therefore, categorized as part of the second subset that is deleted. There are more complex scenarios, where web calls to a target IP address, server, or website at certain dates or times may be on the allowed list, but web calls to the same destination or server at different times may not be on the allowed list. For example, a laptop or other user device 105 that is connected to enterprise 100 that makes a web call to a foreign based IP address during certain hours may be considered “normal” or “safe” by enterprise 100. However, accessing that same foreign based IP address outside certain acceptable “working hours” may be anomalous, and therefore the web call entry of accessing this website may be categorized as of concern and may not be made part of the second subset to be deleted.

With continued reference primarily to FIG. 2 together with FIG. 1, C&C allowed list 142 may include data or information about destinations such as allowed IP addresses, servers, websites, and host machines or services. The allowed list may be manually compiled or created, or it may be automatically created, edited and updated based on previous communication or web calls to these destinations by one or more of user devices 105 or machines on enterprise 100. The allowed list generally contains safe destinations or destinations marked as safe. Certain destinations may be on C&C allowed list 142, FIG. 1, under certain predefined conditions based on the time and/or source of the web calls to such destinations, and/or specific tasks associated with the web call. For example, a first destination can make the allowed list 142 only if the web call to the first destination took place during a predefined time range and/or was sourced from certain user devices 105 or users, or if it is associated with a specific task. On the contrary, the first destination may not make the allowed list 142 if the web call to the first destination took place outside the predefined time range and/or was sourced from devices or users that are not predefined.

Furthermore, some actions may be deemed safe and also be on C&C allowed list 142, FIG. 1, for example navigating the home page of a website, but then other actions relating to the same destination such as downloading images from the website, making web calls to a destination during certain times, hours, or alongside certain events, or navigating to other locations within a website or clicking certain links may be excluded from C&C allowed list 142, FIG. 1.

With continued reference primarily to FIG. 2 together with FIG. 1, method 200 may continue with a deletion 230 of a third subset of concatenated contents from the concatenated contents for failure to satisfy a time-based login threshold. All records that are outside a specific time range since a last login, for example over 5 days since last login are deleted 230, due to an inactive status, for example. User devices 105 determined to be inactive should not be monitored, and data associated with such devices become irrelevant to enterprise 100. In some aspects, the data falling outside of a specific time range since a last login may be archived or stored, or at least a portion thereof may be archived or stored, permanently or temporarily for a specified period.

Method 200 continues to determine 235 a data upload parameter associated with an undeleted subset of the concatenated contents. A data upload parameter may in various instances be a data download parameter of the remaining subset of the concatenated contents. The data upload or download parameters may include a data download rate or data upload rate, i.e., how fast data is being downloaded from, or uploaded to a destination such as a host server. Furthermore, the data upload parameter may also include a data download or data upload period, i.e., the length of time that data is downloaded from or uploaded to a destination. Other upload parameters may include the size of upload or download from a destination, the number of uploads or download to or from a destination, the number of messages sent to or from a destination and user device 105. Other data upload or download parameters include the types of files uploaded to or downloaded from a destination, respectively.

With continued reference primarily to FIG. 2 together with FIG. 1, in various aspects, the data upload or data download parameters may include or be associated with information related to specific destinations, websites, IP addresses, servers, names of entities, transmitted files, types of files transmitted, file names, and any data or information related to communication from user device 105 with an external destination. Finally, method 200 may identify 240 anomalous behavior associated with the undeleted subset of the concatenated contents based on determined values of the data upload parameter. This anomalous behavior may be associated with one or more user devices 105, for example, if the data upload rate associated with such devices 105 to a website or a specific server is equal to or greater than a predetermined threshold. In several aspects, there needs to be a specific combination of data upload parameters and other factors for behaviors to be identified as anomalous. The other factors may include a time stamp, involvement of a specific user or group of users, or specific user machines or devices 105, repeated events, and/or repeatability of events at certain frequencies, times, periods, lengths, and/or involving specific actors.

With continued reference primarily to FIG. 2 together with FIG. 1, in several aspects, method 200 may include an alert, event, or specific response or action being triggered based on an identification of anomalous behaviors. The alert, event, or action that occurs, or the specific response to identify anomalous behaviors may occur with, or on an SIEM, or other security system or protocol. These alerts, events, or actions may occur individually or in combination with other alerts, events or actions. Alerts, events or specific events may be undertaken by system 100, FIG. 1, autonomously. For example, the system may react to identified anomalous behavior by deleting identified malicious scripts or files, sequestering one or more user devices 105, FIG. 1, or updating a list such as a C&C watch list 189, FIG. 1, or C&C allowed list 142, FIG. 1, or the like with entries relating to the identified anomalous behavior, for example similar to adding entry 175, FIG. 1. An example response may include an alert being generated by the system 100, FIG. 1, and then transmitted to user(s), user devices 105, FIG. 1, or to administrative devices or employees/managers automatically and displayed on their devices. Specific rules may be set manually, or automatically to determine who or which machines or user devices 105, FIG. 1, receive the alert. The autonomous responses, and identification of behaviors may be learned via a trained reinforcement learning network that observes and learns from events or processes 205-240. System 100, FIG. 1, may also be trained to act autonomously as a supervised or semi-supervised network that is fed labeled or semi-labeled data to identify and respond to various records, activities and behaviors on enterprise 100, FIG. 1.

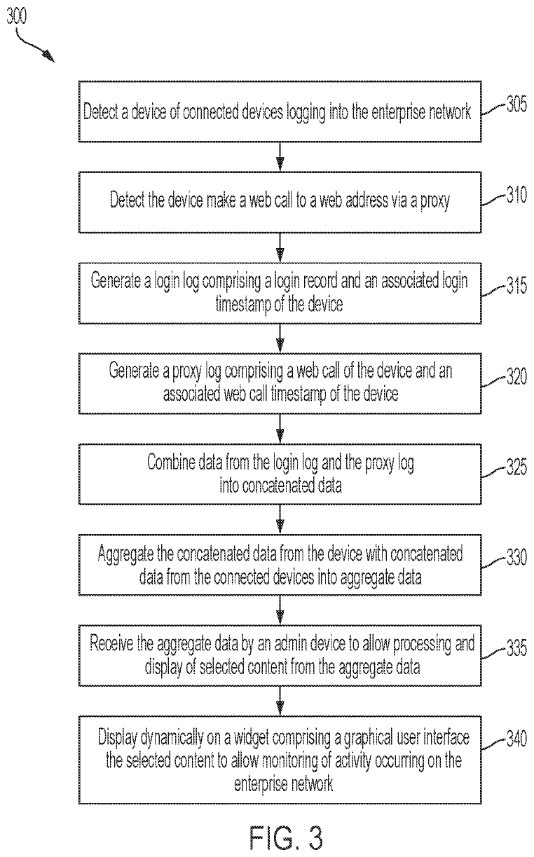

FIG. 3 illustrates a flow diagram for another aspect of a method 300 to monitor computer networks via an intelligent widget, according to at least one aspect of the present disclosure. Discussing FIG. 3 together with FIG. 1, in one aspect, method 300 to monitor computer networks via an intelligent widget, method 300 may commence by detection 305 of a device such as user device 105, FIG. 1 logging into an enterprise network, the method may continue by detection 310 of the device making a web call to a web address via a proxy. The web address may be any destination as described in this document. Method 300 may continue by generating 315 a login log comprising a login record and an associated login timestamp of the device, the login log directly associated with detection 305 of the device logging into the enterprise network. Subsequently, method 300 may also include generation 320 of a proxy log comprising a web call of the device and an associated web call timestamp of the device. The data from the login log and the proxy log may be combined 325 into concatenated data or concatenated records. Login logs, proxy logs, and concatenated data/records may be generated by several devices individually, or generated for each device by the network. Regardless of the method, the logs and data from all the devices, whether concatenated or not, may be aggregated. In several aspects the already concatenated data from each device is combined or aggregated 330 with concatenated data from all the other devices. Aggregation 330 creates aggregate data or aggregate records that may be used by an enterprise to monitor the activity and behaviors of devices across the network.

In several aspects, an administrative device, or admin device, belonging to a security manager, user, or administrator of the network may receive 335 the aggregate data, or in some other aspects access 335 the aggregate data already stored elsewhere on the network to allow processing and display of at least selected content from the aggregate data. Depending on the user interface several aspects of the data may be displayed. Finally, the admin device may display 340 dynamically on a widget comprising a graphical user interface the selected content to allow monitoring of activity occurring on the enterprise network. The admin user may monitor activities and behaviors of several machines on the network, and receive status updates, alerts, or events, regarding individual devices, or groups of devices.

With reference now primarily to FIG. 3 together with FIGS. 1 and 2, in various aspects method 300 may also include instructions to identify, in the aggregate data, a first group of entries that fall outside a predetermined time-criteria. This may, for example, be similar to the first subset of concatenated contents or records in deletion 220, FIG. 2. In several aspects, method 300 may continue to identify, in the aggregate data, a second group of entries associated with web addresses in an allowed list, similar to the second subset of concatenated contents or records in deletion 225, FIG. 2. Further, method 300 may identify, in the aggregate data, a third group of entries that fall outside a predetermined date range, which may for example comprise the third subset of concatenated contents or records similar to deletion 230, FIG. 2. Method 300 may include deletion of the first group, the second group, and/or the third group of entries from the aggregate data.

Method 300 may also cause the enterprise network 100, FIG. 1, for each remaining data entry in the aggregate data, to trigger a security information and event management event based on a match between the data entry and a command and control list, for example similar to trigger alert or event 170, FIG. 1, or add the data entry to the command and control list, similar to adding entry 175, FIG. 1, for example, if it does not contain any matches with the command and control list. The matches may be related to, and determined to be based on, one part of a data entry, or may be related to the full data entry.

With continued reference now primarily to FIG. 3 together with FIGS. 1 and 2, the widget that is displayed by method 300 may be displayed on any device in the enterprise network 100, FIG. 1, including any user device 105, FIG. 1, which may include a device, a client device or an admin or security device. For example, the widget may be displayed on a device of a marketing team employee, or it may be on an admin device of a security manager or administrator of the network. The widget may display various informational details of the activities occurring on enterprise network 100, FIG. 1, which is being monitored. This information may be live information or it may be information that is processed and then displayed on the widget. In several aspects, user devices logging into the system, making web calls or attempting to communicate to outside servers or hosts, for example similar to events or processes 107, 109, 113, and 117, FIG. 1, may be displayed on the widget. The Information includes live login status of connected user devices 105, a live web call status of the connected user devices 105, communications between connected user devices 105, communications between the connected user devices 105 and external servers or destinations, the security information and event management event, and/or a status of the SIEM event, the status or current state of allow or command and control lists. Data concerning or associated with events or processes or a current state of events or processes including any of 113, 117, 130-175, FIG. 1, may all be displayed individually for individual devices or as aggregated data for all enterprise 100.

Aggregated or post processed information or data associated to activities occurring on individual user devices 105, FIG. 1, or aggregated information from multiple user devices 105, FIG. 1 may also be displayed on the widget. For example, the widget may display aggregate numbers of users or devices logged into the network, or users or devices that are offline, the number of total web calls being made on the system, the type of web calls being made, the destinations or types of destinations being communicated to, the total number or rate of malicious activity or activities of concern, the size of files uploaded or downloaded, the frequency rate of uploads, time period of uploads, the number of potentially malicious uploads or downloads, statistical analysis of these activities such as averages, ranges, differences between days or time periods, and/or frequency rates of activity. The widget may also allow a security controller or administrator to click on these numbers and pinpoint target specific devices.

Based on a combination of these factors, the widget may also provide a security score for each user device 105 indicating the level of threat or security of a user device in the network, and provide the administrator options for specific actions to be taken, such as a selectable option to undertake such as, for example, sequestration of the device from the network, deletion of the malicious code or script from the device, issuance of an alert to the device, disabling the device, shutting down the enterprise network, and/or displaying other event or alert options on the widget. Apart from the data generated in the processes in systems and methods of FIG. 1-3 and 4A-C, the widget may also use a variety of data sources, from which information could be analyzed and displayed, or automatically responded to. These include an active directory, VPN Logs, NAC Logs or other system which logs initial user login action. While for offline or offnet activity, where a user of a user device 105 may not have logged in, the widget may retrieve cloud-based tooling logs to process and display.

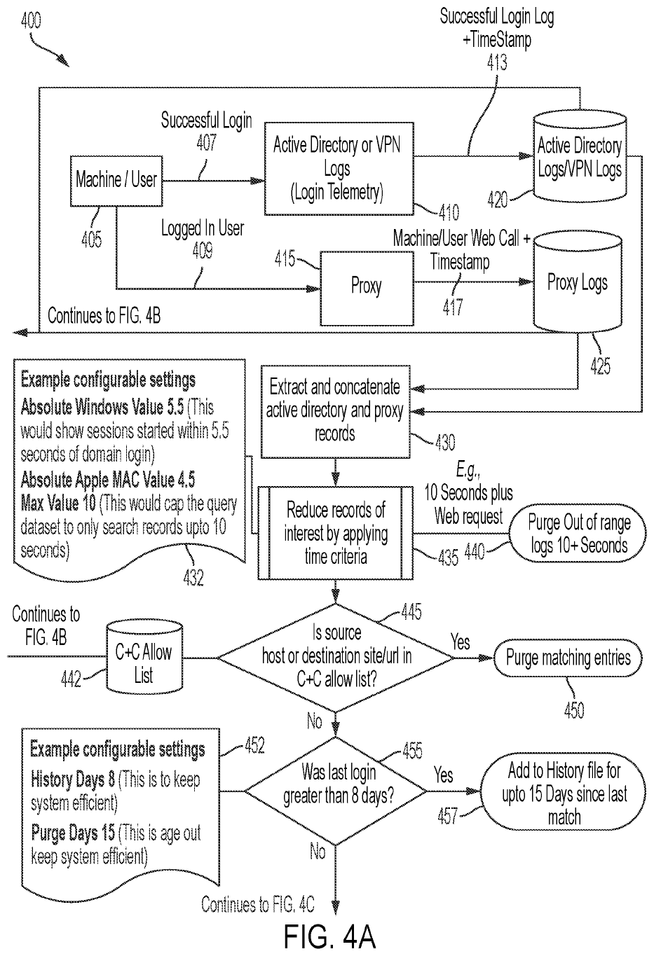

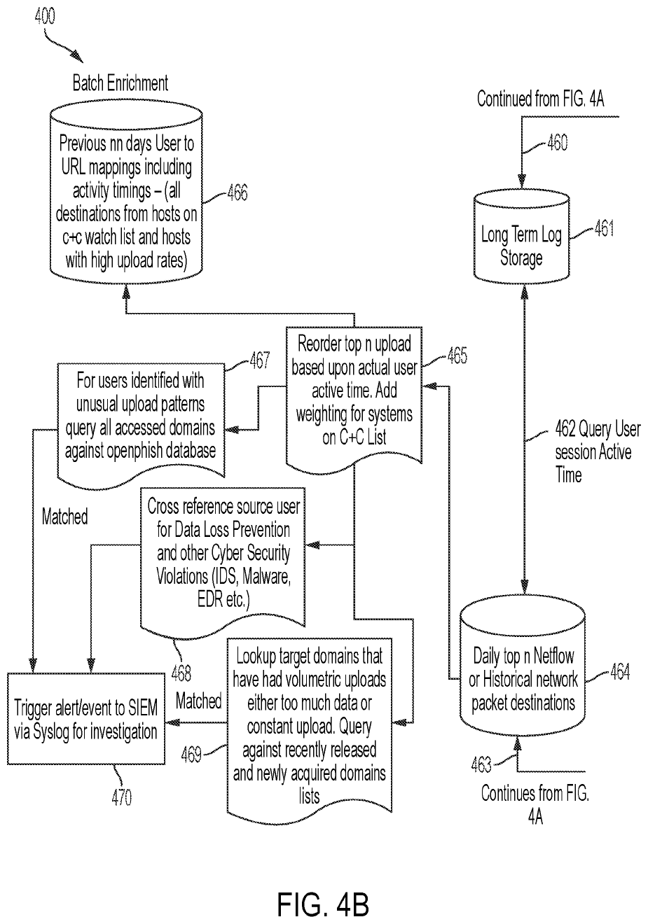

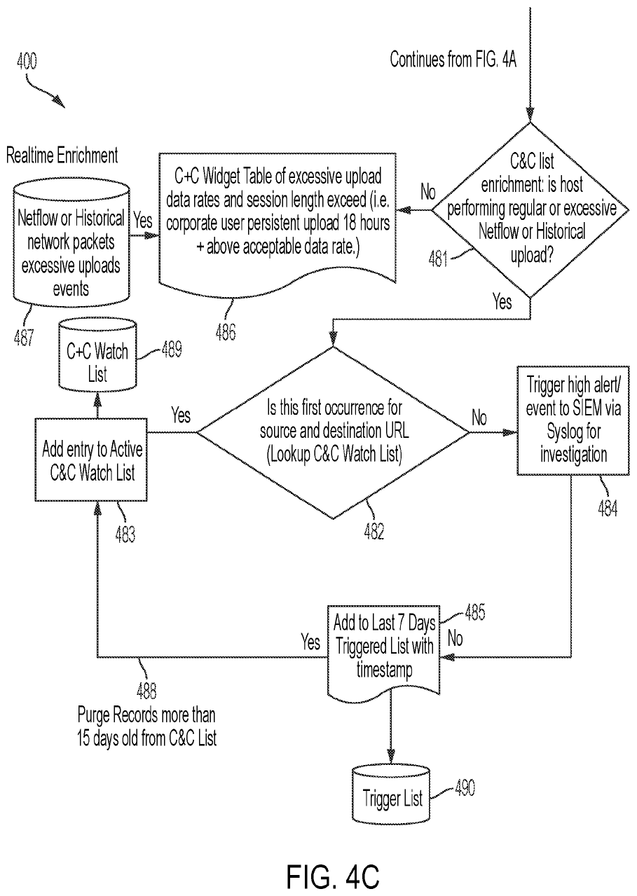

FIGS. 4A-4C illustrate comprehensive systems and methods to manage command and control threats, according to at least one aspect of the present disclosure. The activities and data generated and produced by system 400 of FIGS. 4A-4C may be fed into a widget for monitoring and managing security threats. The widget may be an intelligent widget that is generated and/or displayed 340 dynamically, FIG. 3. FIG. 4A illustrates systems 400 and methods to manage command and control threats according to at least one aspect of the present disclosure. System 400 (also referred to herein as “enterprise 400”, “network 400”, and “enterprise network 400”), which may comprise an enterprise network, may include one or more computing or networking devices, client devices, machines, or user devices 105 (collectively referred to herein as “user device(s)”). A user device 405 may include devices for any individual connected to the enterprise network, including employees, contractors, and security and network administrators. Enterprise 400 may be a local or a distributed system or a combination of both. Multiple user devices 405 may be connected via and/or to system 400. A user, for example, may be an employee or a contractor of an organization that owns an enterprise 100 that may log into 407 user device 405, for example a work laptop or computer. A user may also be, for example, a guest user that is issued a temporary user name and password or guest account credentials. Once a user logs in 407 successfully, they are able to access active directory 410 which may include one or more directories, files, folders, programs, virtual machines, and/or applications that are part of or connected to enterprise 400. User device 405, or enterprise 400 may generate login information 413 that may include a time stamp of successful login 407, and/or a successful login log of user device 105. Login information 413 may then in various aspects be automatically copied to, or stored in, active directory logs 420.

An already logged in 409 user or user device 405 may also access a proxy server 415 (also referred to herein as proxy 415) which allows communication between, or forms a communication channel to, external web addresses or destinations, and acts as an intermediary between a client requesting a resource and the server providing that resource. Logged in user 409 with access to enterprise 400, may connect to external destinations, such as websites or servers through proxy 415 via web calls made by user device 405. User device 405, proxy 415, or enterprise 400 may generate web access information 417 that may include information about specific web calls made by user device 405, such as an IP address, as well as timestamps associated with the web calls made. Web access information 417 may include any type of information, data, or files exchanged as a result of the web call. Web access information 417 may be copied to, or stored in, proxy logs 425. Web access information 417 stored in proxy logs may be flagged as problematic or as potentially malicious by system 400 if it meets certain criteria, for example, excessively rapid internet calls, or internet calls within a specific time range from login. In one example, a user logs into a user device 405, and user device 405 immediately, or after a short period that may be set as a threshold by system 400, makes a web or internet call. This may be considered as anomalous behavior and flagged for action by system 400, since it may indicate an automated web call by a malicious script or code that has gained a foothold on user device 405. This may occur automatically or via the events or processes described within system 400.

Active directory logs 420 and proxy logs 425 may each be comprised of various logs, files, folders and databases. Login information 413 and web access information 417 stored in active directory logs/VPN logs 420 and proxy logs 425, respectively, may be identified, searched, extracted, copied, edited, retrieved, or pulled to be concatenated 430 together into concatenated records or concatenated data. Based on the timestamps generated in login information 413 and web access information 417, the concatenated records could be reduced by applying 435 time criteria to them and deleting 440 or purging 440 any record that falls outside of a specific date, time, or time range/difference; for example, logs generated within a specific time range, such as 10 seconds, from a login or web access request. In various aspects, configurable settings 432 are pre-set or pre-determined and may be applied to records generated from user devices 405. These configurable settings 432 may be set manually by an administrator or automatically by system 400 based on learned behaviors and thresholds designed to either capture most threats, designed for accuracy, or designed to generate results efficiently, for example. In several aspects, records are parsed for the shortest user device 405 login time and with the quickest internet connections within login time (or a specific time frame or period within login time). The thresholds and time ranges between the activities of login time, internet calls, or other communications may be determined and set automatically and autonomously by the system, for example with the application of specially trained ML models as disclosed herein.

Configurable settings 432 may vary from records originating from one operating system to another. For example, configurable settings may set a value of 5.5 seconds for records generated by a Windows™ user device 405, while setting a value of 10 seconds for records from a Mac OS™ based user device 405. Anything outside of these pre-set configurable ranges defined by configurable settings 432 may be purged 440 or deleted from the records of interest. Once records are reduced 435 by applying time criteria to them, the enterprise 400 determines 445 whether the destination website accessed, URL, IP address, or the source host (collectively referred to herein as “destination”), via a web call, for example, is in one or more allow lists 442 maintained by enterprise 400. If the destination is in an allow list 442 or whitelist 442, then the entries from the combined records at concatenation 430 may be further reduced by deleting 450 entries from active directory logs 420 and proxy logs 425 that are in, or match, entries in allow list 442. Any type of destination including host servers, URLs, websites, IP addresses may all be on an allow list.

The concatenated records may be further reduced by identifying 455 the date of the last login, and if the last login is outside of a predefined time-range, for example 3 days, the entries associated with login records outside of the predefined time-range may either be deleted, transferred, added or copied 457 into a history directory, file, folder or database. In several aspects, configurable settings 452 may be set to determine the time periods to add the records to a history file. Time periods may be set for records to be considered relevant, placed in a history file, or to be purged. Configurable settings 452 may be determined automatically by the system 400 or manually by security managers or administrators. For example, configurable settings may be set to include as records of relevance all records 8 days or less old, or all records from devices with a login of 8 days or less (“relevant period”), and add any records to a history file that are either between 8 and 15 days, or where the record is from a device of between 8-15 days (“history period”), and purge anything over 15 days old or where the record is from a user device 405 that last logged in over 15 days ago (“purge period”). These time frames provided for the relevant period, history period, and purge period are only examples, and any of these periods may be set as any time length, including minutes, hours, weeks, and the like. Further, periods may be set for other actions to occur to the records, for example, a period for records to be stored in a specific location, or for records to be delivered to another application or container in the network for further processing or analysis. Some periods may overlap, or some records may be subject to more than one action. The remaining records that are deemed relevant are selected records that have been processed and were not deleted, stored elsewhere or removed from the concatenated records after going through events or processes 435, 445, and 455. These remaining records may also be cleared periodically depending on the storage requirements of the system 400 and as new data is retrieved or extracted.

Patterns are identified in the data generated by the system, in various aspects by reinforcement machine learning or other machine learning algorithms and processes. Once patterns are identified, new rules, or recognized situations or specific combinations of data points may be automatically created that may trigger specific actions in enterprise 400. For example, enterprise 400 may recognize various iterations of the methods described, or that specific combinations, or factors in login information 413 and/or web access information 417, may be related to specific actions such as adding an entry to a C&C watch list or triggering alerts or events in the SIEM. In various aspects, user devices 405 that initiate a web call within a specific time range from a successful login 407, or a web call within a certain range from a specific time or date, may be flagged by the enterprise 400 to be an event that is of concern, and necessitates triggering of an action, such as an alert to or by the SIEM. In various aspects, the enterprise 400 may determine or identify that a web call falling within a certain time, or range from another event such as a successful login 407, must also be accompanied by trying to access or communicate with a certain destination, such as a host server, website, service, or IP address, for it to be a flagged event that triggers an alert or another action of the enterprise 400. Various actions or responses may be autonomously undertaken by the system 400, including adding or removing not just the concatenated entries, but fields and specific data points from the entries such as events, timestamps, destinations, and the like, to lists such as a C&C watch list 489 or an allowed list 442 (may be referred to as a “C&C allowed list”).

FIG. 4B illustrates a batch enrichment component of enterprise or system 400 that is designed to determine patterns and further extract relevant security threat information from the data logs. In numerous aspects, the active directory logs/VPN logs 420 and the proxy logs 425 may be input 460 either in their raw format or after further processing and/or concatenation from extraction or concatenation 430 into a long term log storage 461. Long term storage may be a node in a distributed system, a storage device, a virtual machine, a database, or dedicated hardware or an enclave in a distributed system. The records in logs 420, 425 after being transferred to long term log storage 461 may be used individually or in combination with other data to determine patterns that may be used by system 400 to establish rules and appropriate responses in different situations. Rules or queries may be set manually or automatically by system 400 to determine specific patterns, including pattern match batch queries looking for domain matches in the records in long term log storage 461 and domain accesses by user devices 405 in network 400, and/or to look for hosts or user devices 405 which are consistently fastest in accessing internet or making destination or web calls after login time. Furthermore, in various aspects, pattern match queries may seek to identify abnormally long session lengths, for example, a user device 405 that has been active for 18+ hours, i.e., not idling.

In various aspects, system 400 may query 462 user session active times as stored in the records in long term log storage 461. In some aspects, record entries communicating to destinations in allow lists are removed 463 from query 462 or from results to query 462. Results are retrieved 464 from long term log storage 461 and may include a top daily or historical number of connections or Netflow data from one or more user devices 405 to one or more destinations. All types of inbound and outbound connections may be captured and retrieved 464 including daily internet connections, destinations, congestions or other network and internet traffic information. Historical packet destinations may be retrieved 464. Retrieval may also include top daily or historical packet destinations from one or more devices. A threshold may be set for the highest number of uploads or network connections, or packet flows, and the data or entries falling within that threshold may be retrieved 464. For example, a certain percentage of all the data may be set, and the records with the highest net flows falling within that percentage may be identified, selected, and/or retrieved 464, for example the records with the highest 5% of total net flows.

In one aspect, the top number of uploads are reordered 465 based upon actual user active times. In some aspects a higher actual user time may increase the relevance of an entry, while in other aspects, a lower actual user time will increase the relevance of the entry and places it higher in the list, since lower active user time, but higher Netflow from a user device 405 may indicate automated malicious scripts being autonomously run on user device 405. In several aspects, if destinations are identified in entries that fall in the C&C watch list 489, then weightings are added to entries containing these destinations of concern, and this is taken into account in the reordering of the records. A certain number ‘nn’ of days, or specific date ranges, may be selected or determined by system 400, and the remaining records falling within a predetermined number of nn days, or the selected date ranges, may have their activities and timings mapped 466. For example, activity logs of users or user device 405 may be mapped to URLs, IP addresses or other destinations. In various aspects, all destinations from hosts or associated with destinations on C&C watch lists 489, or destinations, hosts, or servers with high upload rates are mapped to activity timings, users, and user devices 405. Patterns may be retrieved from event or process 466 that could be used as a baseline, or as indicators of security threats within system 400.

In several aspects, entries identifying users or user devices 405 placed highest in order of priority in regards to their status as indicating possible security threats, and in several aspects if the entries identify the users or user devices 405 having unusual upload patterns, query 467 all domains accessed by that user or user device 405. In many aspects the query is run against an Openphish database or other intelligent phishing security platform. If a match is found between the domains accessed by that user and phishing attempts, then an alert or event is triggered 470, in many aspects via Syslog or other system logging protocols in order to be investigated. The alert or event may be communicated to the SIEM. In several aspects, after reordering and adding weightings 465, the reordered records and entries of an actual user may be cross referenced 468 against a source user; the source user may be an admin, domain administrator, or account user.

Cross referencing 468 the source user may be undertaken for data loss prevention and other cyber security violations (IDS, malware, EDR etc.). If data loss or the other cyber security violations are detected based on cross referencing 468, an alert or event is triggered 470, in many aspects via Syslog or other system logging protocols in order to be investigated. The alert or event may be communicated to the SIEM. In several aspects after reordering and adding weightings 465, target domains or destinations that are identified as those that have the highest volume in terms of uploads, unusual amount of data, or continuous or constant uploads may be looked up by querying 469 these destinations or domains against recently released and newly acquired domains lists. Querying 469 may be used as an enrichment step to reduce false positives. False positives may fall into the following two areas: of newly registered destinations or domains and of expired destinations or domains. Newly registered destinations or domains are suspicious by lack of any form of history, reputation, or previous background in the system, but may be harmless, while expired domains or destinations should in theory no longer be in use, so their use may indicate a known method for deviating URL filtering for malicious activity, although this may also be not actual malicious activity. Therefore, depending on the destination, and the configuration of the system, these may be ignored, or may be used to indicate malicious activity. If the querying 469 indicates suspicious activity, then an alert or event is triggered 470, in many aspects via Syslog or other system logging protocols, in order to be investigated. The alert or event may be communicated to the SIEM.

FIG. 4C illustrates a component that includes the real-time enrichment of the C&C watch list 489 in system 400 to detect repeat occurrences of malicious behaviors or behaviors of concern, especially those related to unusual internet upload rates. The C&C watch list 489 contains threats, destinations of interest, and identified domains or hosts that trigger alerts or warnings and are a security concern to system 400. The C&C watch list 489 may in several aspects have entries added to it by the events or processes in FIG. 1 of system 100, and especially events or processes 130-175. In several aspects, once the concatenated records go thorough events or processes 435-457, are purged 440, 450, and are within a login time period range as determined by events or processes 455 and 460, the records are parsed to determine 481 if a host or user device 405 is performing regular or excessive uploads. The system 400 may determine if a host or user device 405 is performing regular or excessive uploads, or if uploads/upload rates are outside of a predetermined “threshold,” by consulting a C&C widget table. The C&C widget table may be populated by records from Netflow or historical network packets, or excessive uploads events, any and all of these may be stored in system 400. The C&C widget table may reorder or display the information in various ways, as well as show statistics or figures derived from the data, for example averages, ranges, maximums and minimums, of for example session lengths, upload data rates, size of upload per host, uploads per time period, and information relating to the types of uploads.

If regular, or excessive uploads are detected or identified, and the determination 481 is that they have been occurring, then system 400 determines 482 whether this is a first occurrence for the source/host or user device 405 and/or the destination. This may be determined by looking up the C&C watch list 489, which contains destinations that may be deemed as security threats; if the destination is not on the watch list 489, then it may be added to the watch list 489. If, however, the destination is on the C&C watch list 489, then this indicates that it is not a first occurrence for the destination to be receiving data uploads from enterprise 400, and it may trigger 484 an alert or event, in many aspects via Syslog or other system logging protocols in order to be investigated. The alert or event may be communicated to the SIEM.

In several aspects if an alert or event is triggered 484, then the alert or event is added 485 to a triggered list 490 with timestamp; the triggered list 490 may contain a list of events and alerts that occurred within a specific time period, e.g., 7 days. The trigger list 490 may be consulted by the system 400, or by the SIEM. The trigger list 490 may also be part of the C&C watch list 489. Records that are of a certain date, or over a certain threshold in terms of their age may be purged 488 with regular frequency from any of the C&C watch list 489, the trigger list 490, and the allow C&C list 442.

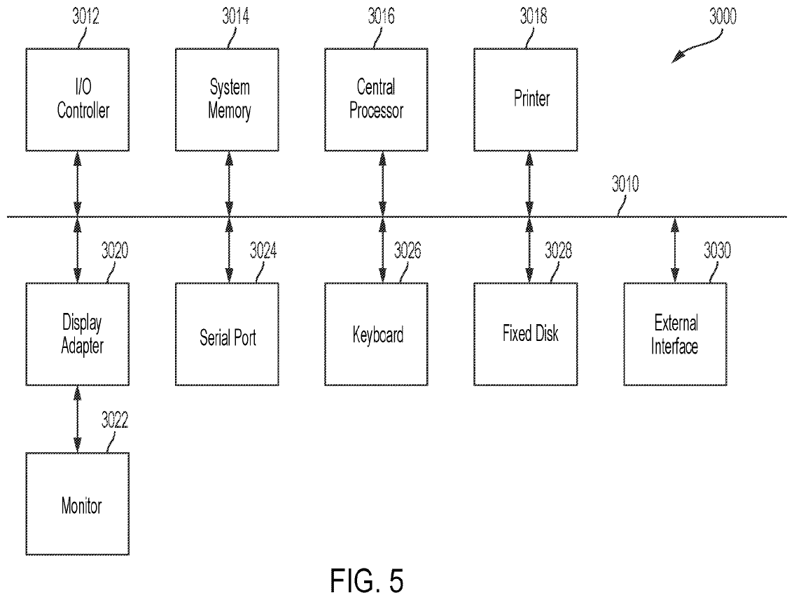

FIG. 5 is a block diagram of a computer apparatus 3000 with data processing subsystems or components, which a set of instructions to perform any one or more of the methodologies discussed herein may be executed, according to at least one aspect of the present disclosure. The subsystems shown in FIG. 5 are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

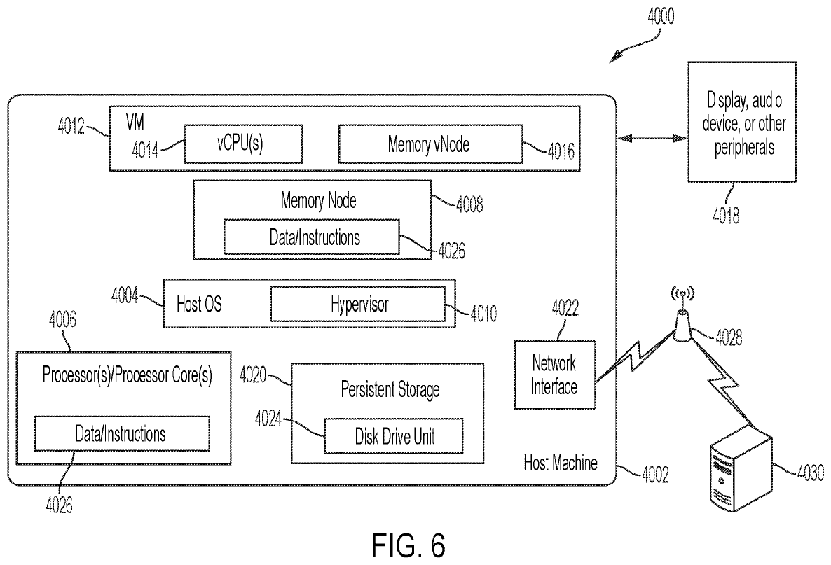

FIG. 6 is a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 3002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational events or processes to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.
Clause 1. A computer-implemented method for improving security of a computer network, the computer-implemented method comprising extracting login telemetry, wherein the login telemetry comprises login records of successful logins to computers in the computer network, and wherein the login telemetry comprises login time stamps associated with the successful logins; extracting proxy logs, wherein the proxy logs comprise records of web calls made from the computers of the computer network to destination websites after the successful logins, and wherein the proxy logs comprise web-call time stamps associated the web calls; generating concatenated contents from the login telemetry and the proxy logs; deleting a first subset of concatenated contents from the concatenated contents for failure to satisfy a time-based selection criterion; deleting a second subset of concatenated contents from the concatenated contents for validating with an allowed list; deleting a third subset of concatenated contents from the concatenated contents for failure to satisfy a time-based login threshold; determining a data upload parameter associated with an undeleted subset of the concatenated contents; and identifying anomalous behavior associated with the undeleted subset of the concatenated contents based on determined values of the data upload parameter.
Clause 2. The computer-implemented method of Clause 1, wherein the allowed list comprises allowed source hosts.
Clause 3. The computer-implemented method of any of Clauses 1-2, wherein the allowed list comprises allowed destination websites.
Clause 4. The computer-implemented method of any of Clauses 1-3, wherein the data upload parameter comprises a data upload rate.
Clause 5. The computer-implemented method of any of Clauses 1-4, wherein the data upload parameter comprises a data upload period.
Clause 6. The computer-implemented method of any of Clauses 1-5, further comprising triggering an alert based on an identification anomalous behavior.
Clause 7. The computer-implemented method of any of Clauses 1-6, further comprising deleting a malicious code.
Clause 8. The computer-implemented method of any of Clauses 1-7, further comprising updating a watch list based on the undeleted subset of the concatenated contents that associate with a malicious code.
Clause 9. A computer-implemented method for improving security of a computer network, the computer-implemented method comprising retrieving login telemetry, wherein the login telemetry comprises login records of successful logins to computers in the computer network, and wherein the login telemetry comprises login time stamps associated with the successful logins; retrieving proxy logs, wherein the proxy logs comprise records of web calls made from the computers of the computer network to destination websites after the successful logins, and wherein the proxy logs comprise web-call time stamps associated the web calls; generating concatenated contents from the login telemetry and the proxy logs; deleting a subset of concatenated contents from the concatenated contents for failure to satisfy a time-based selection criterion; deleting a second subset of concatenated contents from the concatenated contents for validating with an allowed list; deleting a third subset of concatenated contents from the concatenated contents for failure to satisfy a time-based login threshold; determining a data upload parameter associated with a remaining subset of the concatenated contents; and identifying malicious code associated with the remaining subset of the concatenated contents based on determined values of the data upload parameter.
Clause 10. The computer-implemented method of any of Clause 9, wherein the allowed list comprises allowed source hosts.
Clause 11. The computer-implemented method of any of Clauses 9-10, wherein the allowed list comprises allowed destination websites.
Clause 12. The computer-implemented method of any of Clauses 9-11, wherein the data upload parameter comprises a data upload rate.
Clause 13. The computer-implemented method of any of Clauses 9-12, wherein the data upload parameter comprises a data upload period.
Clause 14. The computer-implemented method of any of Clauses 9-13, further comprising triggering an alert based on identifying the malicious code.
Clause 15. The computer-implemented method of any of Clauses 9-14, further comprising deleting the malicious code.
Clause 16. The computer-implemented method of any of Clauses 9-15, further comprising updating a watch list based on an undeleted subset of the concatenated contents that associate with the malicious code.
Clause 17. An automated system for monitoring computer networks via an intelligent widget, the system comprising an enterprise network comprising connected devices; and a memory storing instructions executable by a processor configured to undertake a set of security monitoring activities for each of the connected devices, wherein the instructions cause the processor to detect a device of the connected devices logging into the enterprise network, the device associated with a user known to the enterprise network; detect a web call by the device to a web address via a proxy; generate a login log comprising a login record and an associated login timestamp of the device; generate a proxy log comprising a web call record of the device and an associated web call timestamp of the device; combine data from the login log and the proxy log into concatenated data; aggregate the concatenated data from the device with concatenated data from the connected devices into aggregate data; and an admin device of the connected devices associated with an administrator known to the enterprise network, wherein the admin device is configured to receive the aggregate data to allow processing and display of selected content from the aggregate data; exclude a subset of the aggregate data based on predetermined criteria; and display dynamically on a graphical user interface of the intelligent widget the selected content to allow monitoring of activity occurring on the enterprise network.
Clause 18. The system of Clause 17, wherein the selected content dynamically displayed comprises at least one of a live login status of the connected devices, a live web call status of the connected devices, communications between the connected devices, communications between the connected devices and external servers or destinations, a triggered event or alert, a status of a triggered event or alert, an allow list, and a command and control watch list.
Clause 19. The system of any of Clauses of 17-18, wherein the instructions executable by the processor further comprise identify in the aggregate data a first group of entries that fall outside a predetermined time-criteria; identify in the aggregate data a second group of entries associated to web addresses in an allow list; identify in the aggregate data a third group of entries that fall outside a predetermined date range; delete the first group, the second group, and the third group of entries from the aggregate data; and for each remaining data entry in the aggregate data, trigger a security information and event management event based on a match between the data entry and a command and control watch list, or add the data entry to the command and control watch list based on an absence of matches with the command and control list.
Clause 20. The system of any of Clauses 17-19, wherein the security information and event management event comprises instructions executable to automatically display on the intelligent widget an option selectable to undertake at least one of sequester the device from the network; delete malicious code or script from the device; issue an alert to the device; disable the device; shut down the enterprise network; or display event or alert options on the widget, the event or alert options selectable by the administrator, or a combination thereof.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method processes when used in a claim. For instance, in describing a method, “comprising” indicates that the claim is open-ended and allows for additional processes. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. A computer-implemented method for improving security of a computer network, the computer-implemented method comprising:
extracting login telemetry, wherein the login telemetry comprises login records of successful logins to computers in the computer network, and wherein the login telemetry comprises login time stamps associated with the successful logins;
extracting proxy logs, wherein the proxy logs comprise records of web calls made from the computers of the computer network to destination websites after the successful logins, and wherein the proxy logs comprise web-call time stamps associated the web calls;
generating concatenated contents from the login telemetry and the proxy logs;
deleting a first subset of concatenated contents from the concatenated contents for failure to satisfy a time-based selection criterion;
deleting a second subset of concatenated contents from the concatenated contents for validating with an allowed list;
deleting a third subset of concatenated contents from the concatenated contents for failure to satisfy a time-based login threshold;
determining a data upload parameter associated with an undeleted subset of the concatenated contents; and
identifying anomalous behavior associated with the undeleted subset of the concatenated contents based on determined values of the data upload parameter.

2. The computer-implemented method of claim 1, wherein the allowed list comprises allowed source hosts.

3. The computer-implemented method of claim 1, wherein the allowed list comprises allowed destination websites.

4. The computer-implemented method of claim 1, wherein the data upload parameter comprises a data upload rate.

5. The computer-implemented method of claim 1, wherein the data upload parameter comprises a data upload period.

6. The computer-implemented method of claim 1, further comprising triggering an alert based on an identification anomalous behavior.

7. The computer-implemented method of claim 1, further comprising deleting a malicious code.

8. The computer-implemented method of claim 1, further comprising updating a watch list based on the undeleted subset of the concatenated contents that associate with a malicious code.

9. A computer-implemented method for improving security of a computer network, the computer-implemented method comprising:
retrieving login telemetry, wherein the login telemetry comprises login records of successful logins to computers in the computer network, and wherein the login telemetry comprises login time stamps associated with the successful logins;
retrieving proxy logs, wherein the proxy logs comprise records of web calls made from the computers of the computer network to destination websites after the successful logins, and wherein the proxy logs comprise web-call time stamps associated the web calls;
generating concatenated contents from the login telemetry and the proxy logs;
deleting a subset of concatenated contents from the concatenated contents for failure to satisfy a time-based selection criterion;
deleting a second subset of concatenated contents from the concatenated contents for validating with an allowed list;
deleting a third subset of concatenated contents from the concatenated contents for failure to satisfy a time-based login threshold;
determining a data upload parameter associated with a remaining subset of the concatenated contents; and
identifying malicious code associated with the remaining subset of the concatenated contents based on determined values of the data upload parameter.

10. The computer-implemented method of claim 9, wherein the allowed list comprises allowed source hosts.

11. The computer-implemented method of claim 9, wherein the allowed list comprises allowed destination websites.

12. The computer-implemented method of claim 9, wherein the data upload parameter comprises a data upload rate.

13. The computer-implemented method of claim 9, wherein the data upload parameter comprises a data upload period.

14. The computer-implemented method of claim 9, further comprising triggering an alert based on identifying the malicious code.

15. The computer-implemented method of claim 9, further comprising deleting the malicious code.

16. The computer-implemented method of claim 9, further comprising updating a watch list based on an undeleted subset of the concatenated contents that associate with the malicious code.

17. An automated system for monitoring computer networks via an intelligent widget, the system comprising:
an enterprise network comprising connected devices; and
a memory storing instructions executable by a processor configured to undertake a set of security monitoring activities for each of the connected devices, wherein the instructions cause the processor to:
detect a device of the connected devices logging into the enterprise network, the device associated with a user known to the enterprise network;
detect a web call by the device to a web address via a proxy;
generate a login log comprising a login record and an associated login timestamp of the device;
generate a proxy log comprising a web call record of the device and an associated web call timestamp of the device;
combine data from the login log and the proxy log into concatenated data;
aggregate the concatenated data from the device with concatenated data from the connected devices into aggregate data; and
an admin device of the connected devices associated with an administrator known to the enterprise network, wherein the admin device is configured to:
receive the aggregate data to allow processing and display of selected content from the aggregate data;
exclude a subset of the aggregate data based on predetermined criteria; and
display dynamically on a graphical user interface of the intelligent widget the selected content to allow monitoring of activity occurring on the enterprise network.

18. The system of claim 17, wherein the selected content dynamically displayed comprises at least one of a live login status of the connected devices, a live web call status of the connected devices, communications between the connected devices, communications between the connected devices and external servers or destinations, a triggered event or alert, a status of a triggered event or alert, an allow list, and a command and control watch list.

19. The system of claim 17, wherein the instructions executable by the processor further comprise:
identify in the aggregate data a first group of entries that fall outside a predetermined time-criteria;
identify in the aggregate data a second group of entries associated to web addresses in an allow list;
identify in the aggregate data a third group of entries that fall outside a predetermined date range;
delete the first group, the second group, and the third group of entries from the aggregate data; and
for each remaining data entry in the aggregate data, trigger a security information and event management event based on a match between the data entry and a command and control watch list, or add the data entry to the command and control watch list based on an absence of matches with the command and control list.

20. The system of claim 19, wherein the security information and event management event comprises instructions executable to automatically display on the intelligent widget an option selectable to undertake at least one of:
sequester the device from the network;
delete malicious code or script from the device;
issue an alert to the device;
disable the device;
shut down the enterprise network; or
display event or alert options on the widget, the event or alert options selectable by the administrator, or a combination thereof.
